(19) United States
(12) Patent Application Publication
(10) Pub. No.: US 2011/0002487 A1
(43) Pub. Date: Jan. 6, 2011

(54) Audio Channel Assignment for Audio Output in a Movable Device

(75) Inventors: Heiko Panther, San Francisco, CA (US); David Julian, Cupertino, CA (US); Roberto G. Yepez, San Francisco, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Apple Inc., Cupertino, CA (US)

(21) Appl. No.: 12/498,230

(22) Filed: Jul. 6, 2009

(51) Int. Cl. H04R 5/02

(52) U.S. Cl. 381/300

(57) ABSTRACT

A device that provides an audio output includes a speaker array mechanically fixed to the device. The speaker array includes at least three speakers. An orientation sensor detects an orientation of the speaker array and provides an orientation signal. An audio receiver receives a number of audio signals that include spatial position information. An audio processor is coupled to the speakers, the orientation sensor, and the audio receiver. The audio processor receives the audio signals and the orientation signal, and selectively routes the audio signals to the speakers according to the spatial position information and the orientation signal such that the spatial position information is perceptible to a listener. The orientation signal may be provided by a compass, an accelerometer, an inertial sensor, or other device. The orientation signal may be provided according to selection of display orientation, shape of touch input, image recognition of the listener, or the like.

### BACKGROUND

1. Field

Embodiments of the invention relate to the field of audio output; and more specifically, to routing audio channels to multiple speakers in a movable device.

2. Background

People generally have a well-developed ability to localize the position of a sound source based on the differences in the way the sound is heard by their two ears. In sound reproduction sound may be recorded in two or more channels of audio material and routed to multiple speakers to provide sound cues that allow the listener to localize the apparent position of the recorded sound in much the same way as the original source could be localized. It is necessary for the listener to be located correctly with respect to the speakers for the spatial position information in the sound reproduction to be perceptible to the listener and permit localization of sound sources in the sound as reproduced by the speakers. Similar considerations apply to synthesized audio material that may be routed to multiple speakers to provide an illusion of localized sound sources.

Audio devices that move with respect to the listener create a challenge for the reproduction of multichannel audio using multiple speakers because the spatial relationship between the listener and the speakers can change and interfere with the listener's perception of the spatial position information. It would be desirable to provide an audio device with multiple speakers that can reproduce multichannel audio material in a way that makes the spatial position information perceptible to the listener while allowing the audio device to move with respect to the listener.

### SUMMARY

A device that provides an audio output includes a speaker array mechanically fixed to the device. The speaker array includes at least three speakers in a non-collinear arrangement. An orientation sensor detects an orientation of the speaker array and provides an orientation signal. An audio receiver receives a number of audio signals that include spatial position information. An audio processor is coupled to the speakers, the orientation sensor, and the audio receiver. The audio processor receives the audio signals and the orientation signal, and selectively routes the audio signals to the speakers according to the spatial position information and the orientation signal such that the spatial position information is perceptible to a listener. The orientation signal may be provided by a compass, an accelerometer, an inertial sensor, or other device. The orientation signal may be provided according to selection of display orientation, shape of touch input, image recognition of the listener, or the like.

Other features and advantages of the present invention will be apparent from the accompanying drawings and from the detailed description that follows below.

### BRIEF DESCRIPTION OF THE DRAWINGS

The invention may best be understood by referring to the following description and accompanying drawings that are used to illustrate embodiments of the invention by way of example and not limitation. In the drawings, in which like reference numerals indicate similar elements:

FIG. 1 is a simplified block diagram of a device that routes channels of an audio source to speakers in a speaker array.

FIG. 2 shows the device of FIG. 1 in another orientation.

FIG. 3 is a simplified block diagram of another device that routes channels of an audio source to speakers in a speaker array.

FIG. 4 shows the device of FIG. 3 in another orientation.

FIG. 5 is a simplified block diagram of another device that routes channels of an audio source to speakers in a speaker array.

FIG. 6 is a table of the routing of audio channels for the device of FIG. 5 in various orientations.

FIG. 7 is a simplified illustration of another device that includes speakers in a speaker array.

FIG. 8 is a simplified block diagram of devices that route audio channels for the device of FIG. 7.

FIG. 9 is a graph of exemplary amplitudes for audio signals being routed to the speakers of the device of FIG. 7 in which amplitudes for signals routed from the “L” channel are shown as negative values.

FIG. 10 is a simplified illustration of another device that includes speakers in a speaker array and a visual display.

FIG. 11 shows the device of FIG. 10 in another orientation.

FIG. 12 is a simplified illustration of another device that includes speakers in a speaker array, a visual display that provides touch input, and a camera.

FIG. 13 is a flowchart of a method for routing channels of an audio source to speakers in a speaker array.

FIG. 14 is a flowchart of another method for routing channels of an audio source to speakers in a speaker array.

FIG. 15 is a flowchart of another method for routing channels of an audio source to speakers in a speaker array.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

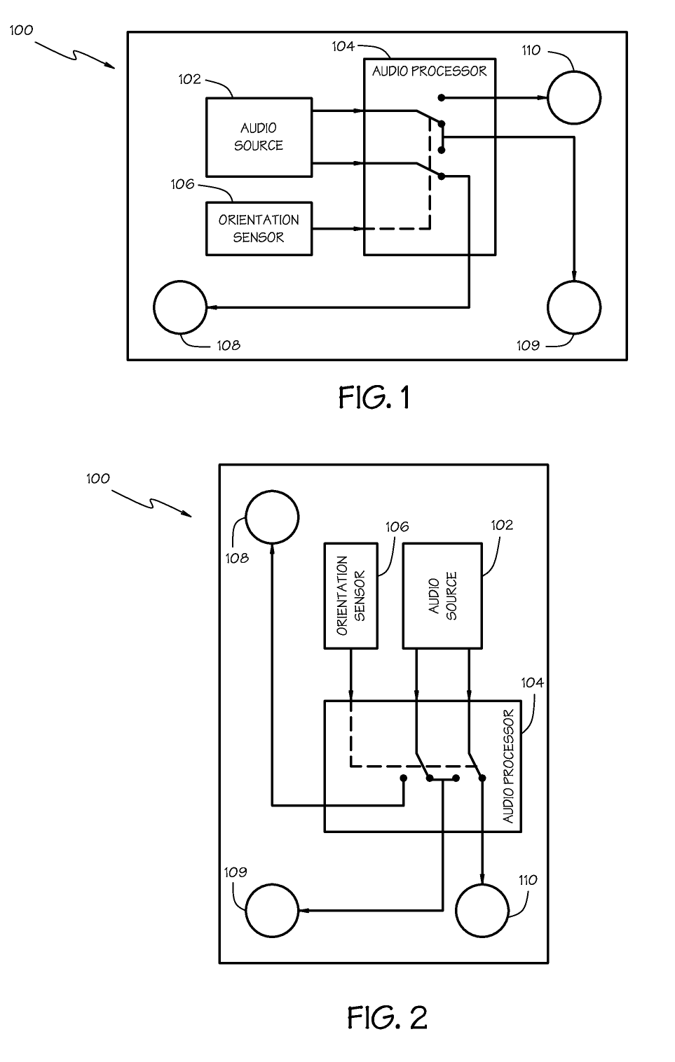

FIG. 1 is a simplified view of a device 100 to provide an audio output. The device includes a speaker array that is mechanically fixed to the device. In the exemplary device shown, the speaker array includes three speakers 108, 109, 110 spaced apart in a non-collinear arrangement to produce the audio output. Each of the speakers may be substantially at the vertices of a polygon having a number of sides equal to the number of speakers in the speaker array. In other embodiments the speaker array may have more than three speakers in a variety of non-collinear arrangements. The term “speaker” may include a closely grouped cluster of speakers that work cooperatively to create an audible sound from an audio channel signal.

The device 100 further includes an orientation sensor 106. The orientation sensor detects an orientation of the speaker array and provides an orientation signal. The orientation sensor may be a compass that is mechanically fixed to the device such that there is no relative movement between the compass mounting and the speaker array. In another embodiment, the orientation sensor may be an accelerometer that is mechanically fixed to the device such that there is no relative movement between the accelerometer mounting and the speaker array. In yet another embodiment, the orientation sensor may be an inertial sensor, such as a gyroscopic type sensor, that is mechanically supported by the device such that there is no relative movement between the inertial sensor mounting and the speaker array.

It will be appreciated that the orientation sensor may provide information about changes in the orientation of the speaker array. The orientation changes may be combined with information about an initial orientation of the speaker array that was properly oriented with respect to the listener. The changes necessary to route the audio signals such that the spatial position information perceived by the listener remains substantially the same as it was in the initial orientation of the speaker array may be derived from the combination of the initial orientation and the orientation changes.

An audio source 102 in the device 100 provides a number of audio signals that include spatial position information. The spatial position information may be encoded with the audio signals, such as being encoded in the differences between the individual audio signals. In other embodiments, the spatial position information may be presented separately from the audio signals. For example, if the audio signals are being synthesized, each audio signal may represent a localized sound source and be accompanied by the spatial position information for that sound source.

An audio processor 104 in the device 100 is coupled to the speakers 108, 109, 110, the orientation sensor 106, and the audio source 102. The audio processor 104 provides a means for receiving a number of audio signals that include spatial position information, a means for receiving an orientation signal that provides an orientation of a speaker array relative to a listener, and a means for processing the number of audio signals according to the spatial position information and the orientation signal to create a speaker signal for each speaker in the speaker array such that the spatial position information is perceptible the listener.

The audio processor 104 receives the audio signals from the audio source 102 and the orientation signal from the orientation sensor 106, and selectively routes the audio signals to at least one of the speakers according to the spatial position information and the orientation signal.

FIG. 1 shows the device 100 in a “landscape” orientation with the wide dimension of the device oriented horizontally. The audio processor 104 routes the audio signals to the speakers with the equivalent of a double pole, double throw switch. It will be appreciated that the audio signals may be routed by any of a variety of electrical means and that the switch shown in the figures is only for the purpose of clearly showing the operation of the audio processor.

In the orientation shown in FIG. 1, a first audio signal is routed to a first speaker 108 that is to the left and a second audio signal is routed to a second speaker 109 that is to the right. Note that a third speaker 110 in the array does not receive an audio signal in this orientation because it is not in a good position for reproduction of a stereo signal since it is not horizontally aligned with the first speaker.

FIG. 2 shows the device 100 of FIG. 1 rotated 90 degrees clockwise to a “portrait” orientation with the narrow dimension of the device oriented horizontally. The orientation signal from the orientation sensor 106 causes the audio processor 104 to reroute the audio signals. In this orientation the first audio signal is routed to the second speaker 109 that is now to the left and which previously received the second audio signal. The second audio signal is routed to the third speaker 110 that is now directly to the right and horizontally aligned with the second speaker. In this orientation the first speaker 108 does not receive an audio signal because it is not horizontally aligned with the remaining speakers.

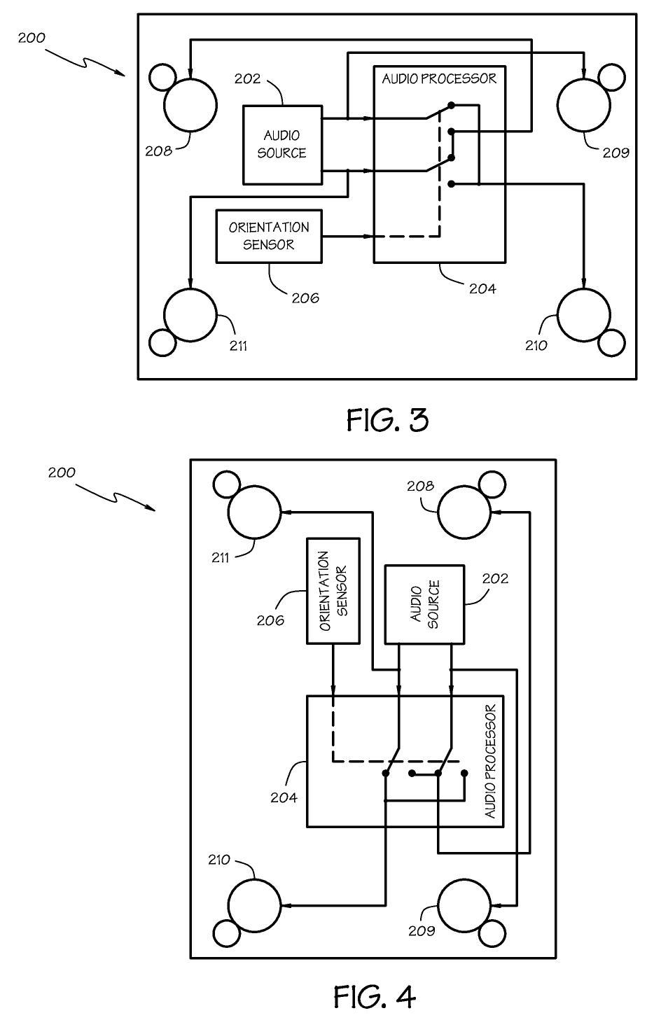

FIG. 3 shows another device 200 that includes a speaker array that includes 4 speakers 208, 209, 210, 211 located substantially at the vertices of a rectangle. As suggested by the two circles shown for each speaker, each speaker is a closely grouped cluster of speakers, such as a high range “tweeter” and a lower range speaker, that work cooperatively to create an audible sound from an audio channel signal. In the “landscape” orientation shown in FIG. 3, a first audio signal is routed to the two speakers 208, 211 on the left and a second audio signal is routed to the two speakers 209, 210 on the right. The two audio signals may represent a left channel and a right channel.

FIG. 4 shows the device 200 of FIG. 3 rotated 90 degrees clockwise to a “portrait” orientation. The orientation signal from the orientation sensor 206 causes the audio processor 204 to reroute the audio signals. In this orientation the first audio signal is routed to the two speakers 210, 211 now on the left and the second audio signal is routed to the two speakers 208, 209 now on the right. Note that one speaker 211 is on the left in both orientations and another speaker 209 is on the right in both orientations. Thus the audio processor 204 only routes the audio signals to two of the four speakers in the array based on the orientation signal from the orientation sensor 206. If two audio signals represent a left channel and a right channel, the left channel audio signal is routed to the speakers on the left of the device and the right channel audio signal is routed to the speakers on the right of the device based on the detected orientation of the speaker array.

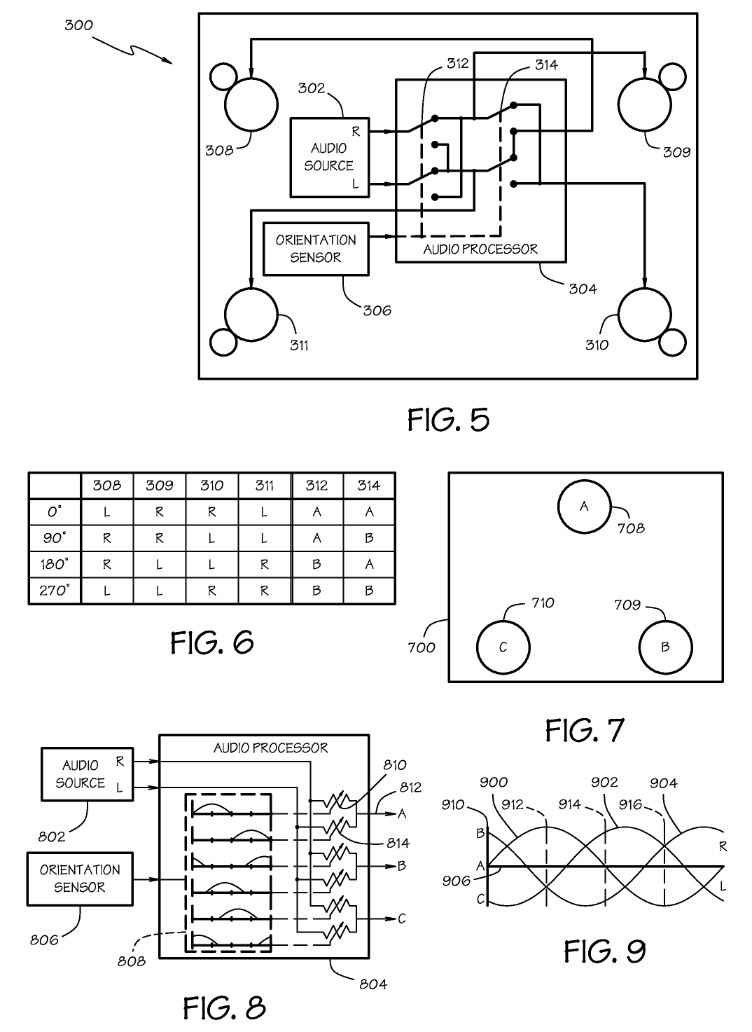

FIG. 5 shows another device 300 that includes a speaker array having four speakers 308, 309, 310, 311. While this device 300 is similar to the device 200 shown in FIGS. 3 and 4, the audio processor 304 is arranged to provide routing for four orientations of the device. The audio processor 304 routes the audio signals to the speakers with the equivalent of two double pole, double throw switches. It will be appreciated that the audio signals may be routed by any of a variety of electrical means and that the switches shown in the figures are only for the purpose of clearly showing the operation of the audio processor. It will be further appreciated that the routing provided by the audio processor 304 may or may not be physically the same as the routing shown by the switches.

FIG. 6 is a table that shows the routing of the audio signals to the four speakers 308, 309, 310, 311 as the device 300 is rotated to the four possible orientations. The entries of “L” and “R” indicate which of the two channels provided by the audio source 302 are routed to each of the four speakers 308, 309, 310, 311 in each of the four possible orientations. The entries of “A” and “B” indicate the routing paths selected by the orientation signal from the orientation sensor is 306 for each of the four possible orientations. FIG. 5 shows the two switches 312, 314 both selecting the “A” routing paths.

In the embodiments described above the audio routing is switched at some point between two orientations. In other embodiments the audio routing may be gradually changed to avoid an abrupt transition point.

FIG. 7 shows another device 700 that includes a speaker array having three speakers 708, 709, 710.

FIG. 8 shows a simplified block diagram of an audio source 802, and orientation sensor 806, and an audio processor 804 that may be used in the device 700 shown in FIG. 7. As suggested by the variable resistors 810, 814, the audio processor 804 in this embodiment routes a selected audio channel to a selected speaker with a continuously variable amplitude controlled by the orientation signal provided by the orientation sensor 806. As suggested by the amplitude signals shown in a processing block 808 for the orientation signal, the audio processor 804 may route the audio signals to the speakers in the speaker array such that the spatial position information is perceptible to the listener independent of the orientation of the device 700.

Considering the “A” speaker 708 which is shown at the top center of the device in the orientation shown in FIG. 7, the signal 812 provided to the speaker by the audio processor 804 does not include either channel of audio signal 810, 814 when the device is in the orientation shown. As the device 700 is rotated clockwise, the audio processor 804 increases the amplitude of the “R” audio signal 810, reaching a maximum amplitude when the device has been rotated clockwise by 90° to place the “A” speaker 708 at its rightmost position. As the device 700 is rotated further clockwise, the audio processor 804 decreases the amplitude of the “R” audio signal 810, such that no audio signal is provided to the “A” speaker 708 when the device has been rotated clockwise by 180°. As the device 700 is rotated still further clockwise, the audio processor 804 increases the amplitude of the “L” audio signal 814, reaching a maximum amplitude when the device has been rotated clockwise by 270° to place the “A” speaker 708 at its leftmost position. As the device 700 is rotated still further clockwise, the audio processor 804 decreases the amplitude of the “L” audio signal 810, such that no audio signal is provided to the “A” speaker 708 when the device has been rotated clockwise to return to the orientation shown in FIG. 7. While a clockwise rotation has been described, it will be appreciated that the device 700 may be rotated in either direction and the audio processor 804 will adjust the audio signal routing accordingly.

FIG. 9 shows a graph of the amplitudes of the audio signals 900, 902, 904 being provided to the three speakers 708, 709, 710. Amplitudes above the X axis 906 represent amplitudes of the “R” audio channel. Amplitudes below the X axis 906 represent amplitudes of the “L” audio channel. It will be appreciated that the amplitudes below the X axis 906 are inverted values and that the amplitude of an audio signal provided to a speaker is always a positive value.

It will be further appreciated that the amplitude curves are idealized and based on the arrangement of three speakers at the vertices of an equilateral triangle. The audio processor may use attenuations for the audio signals that are substantially different from the idealized curves shown. For example, the curves may include level sections around orientations 910, 912, 914, 916 that represent “normal” orientations of the device 700 so that small rotations from these positions do not change the audio routing. The curves may be deliberately distorted based on empirical tests, so that the perceived spatial position information perceptible to the listener is relatively independent of the orientation of the device 700. Very in us in the number and layout of speakers in the speaker array will of course affect the form of the curves used by the audio processor.

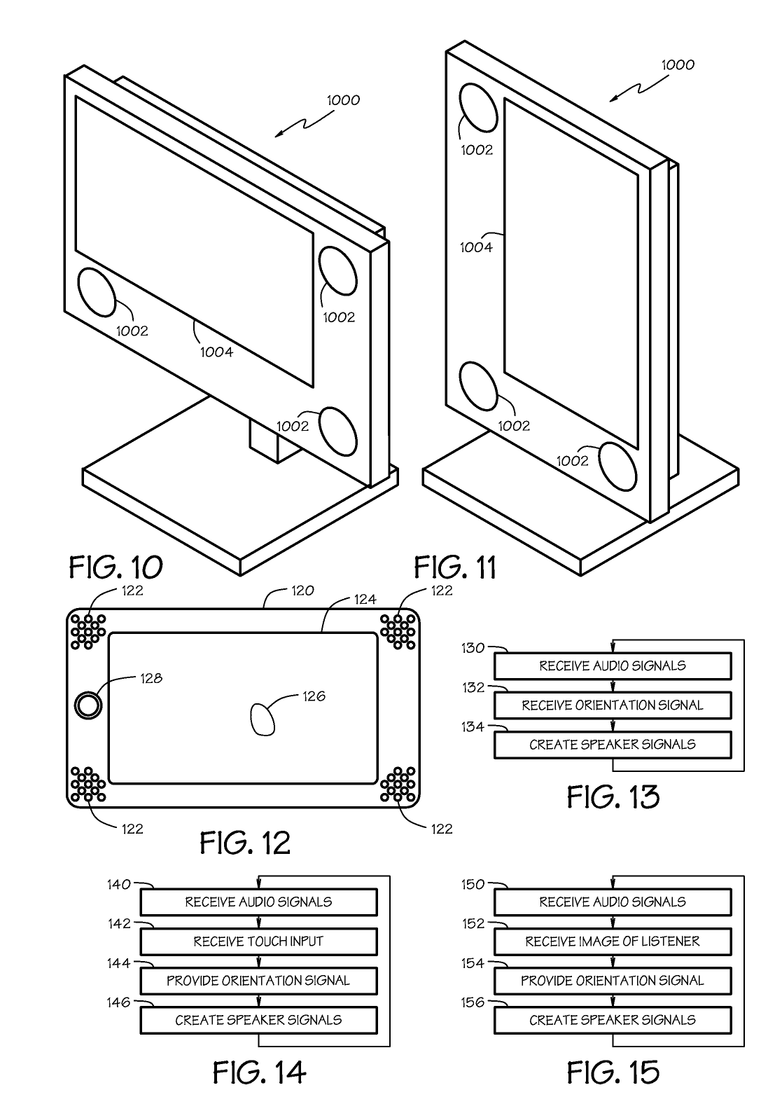

FIGS. 10 and 11 show yet another device 1000 that includes a speaker array 1002. The device further includes a graphical display 1004. The device may be adjusted to be placed in at least two different orientations as shown in the two figures. The orientation sensor may be provided by the graphical display 1004 and also served the function of adjusting the graphical display according to the orientation of the device 1000.

FIG. 12 shows yet another device 120 that includes a speaker array 122. The device may be a portable device and may include a visual display 124. The visual display may provide a touch sensitive input such that the display is also a graphical user input device. The device 120 may include an audio source, an orientation sensor, and an audio processor to route the audio source to the speaker array according to input from the orientation sensor as described above. The orientation sensor may provide the orientation of the device 120 relative to a user of the graphical user input device 124. For example, the input device may receive a display orientation input from the listener who is also the user of the input device, such as by receiving a gesture from the user that orients the display. The display orientation input may adjust the presentation of the visual display to the listener and may provide the orientation signal according to the orientation of the visual display.

As another example, the graphical user input device may receive a touch input 126 from the listener, and provide the orientation signal according to a shape of the touch input, wherein the shape may reflect the orientation of the listener's finger or the motion of the finger from which the orientation of the user in relation to the display may be deduced.

In yet another embodiment, the orientation sensor may include a camera 128 that is mechanically fixed to the device and an image recognition processor coupled to the camera. The orientation signal may provide the orientation of the device relative to a user as detected by the image recognition processor. The orientation signal may be provided according to a location of the listener in the image or according to recognition of facial features of the listener in the image.

FIG. 13 is a flowchart of a method for processing audio signals. A number of audio signals that include spatial position information are received 130. An orientation signal is received 132. The orientation signal provides an orientation of a speaker array relative to a listener, the speaker array including at least three speakers. The number of audio signals are processed according to the spatial position information and the orientation signal to create a speaker signal for each speaker in the speaker array such that the spatial position information is perceptible the listener 134.

FIG. 14 is a flowchart of another method for processing audio signals. A number of audio signals that include spatial position information are received 140. A touch input is received from the listener 142. The orientation signal is provided according to a shape of the touch input to provide an orientation of the speaker array relative to the listener 144. The number of audio signals are processed according to the spatial position information and the orientation signal to create a speaker signal for each speaker in the speaker array such that the spatial position information is perceptible the listener 146.

FIG. 15 is a flowchart of another method for processing audio signals. A number of audio signals that include spatial position information are received 150. An image of the listener is received 152. The image is processed to provide the orientation signal 154. The orientation signal may be provided according to a location of the listener in the image. In another embodiment the orientation signal may be provided according to recognition of facial features of the listener. The number of audio signals are processed according to the spatial position information and the orientation signal to create a speaker signal for each speaker in the speaker array such that the spatial position information is perceptible the listener 156.

While certain exemplary embodiments have been described and shown in the accompanying drawings, it is to be understood that such embodiments are merely illustrative of and not restrictive on the broad invention, and that this invention is not limited to the specific constructions and arrangements shown and described, since various other modifications may occur to those of ordinary skill in the art. The description is thus to be regarded as illustrative instead of limiting.

What is claimed is:

1. A device that provides an audio output, the device comprising:
a speaker array that is mechanically fixed to the device, the speaker array including at least three speakers in a non-collinear arrangement to produce the audio output;
an orientation sensor, the orientation sensor to detect an orientation of the speaker array and provide an orientation signal;
an audio source to provide a plurality of audio signals that include spatial position information; and
an audio processor coupled to the speakers, the orientation sensor, and the audio source, the audio processor to receive the audio signals and the orientation signal, and to selectively route the audio signals to at least one of the speakers according to the spatial position information and the orientation signal.

2. The device of claim 1, wherein the orientation sensor is a compass that is mechanically fixed to the device such that there is no relative movement between the compass mounting and the speaker array.

3. The device of claim 1, wherein the orientation sensor is an accelerometer that is mechanically fixed to the device such that there is no relative movement between the accelerometer mounting and the speaker array.

4. The device of claim 1, wherein the orientation sensor is an inertial sensor that is mechanically supported by the device such that there is no relative movement between the inertial sensor mounting and the speaker array.

5. The device of claim 4, wherein the inertial sensor is a gyroscopic type sensor.

6. The device of claim 1, wherein the orientation sensor is a graphical user input device that is mechanically fixed to the device such that there is no relative movement between the input device and the speaker array, the orientation signal providing the orientation of the device relative to a user of the graphical user input device.

7. The device of claim 1, wherein the orientation sensor includes a camera that is mechanically fixed to the device and an image recognition processor coupled to the camera, the orientation signal providing the orientation of the device relative to a user as detected by the image recognition processor.

8. A method for processing audio signals, the method comprising:
receiving a plurality of audio signals that include spatial position information;
receiving an orientation signal that provides an orientation of a speaker array relative to a listener, the speaker array including at least three speakers in a non-collinear arrangement; and
processing the plurality of audio signals according to the spatial position information and the orientation signal to create a speaker signal for each speaker in the speaker array such that the spatial position information is perceptible the listener.

9. The method of claim 8 further comprising receiving a display orientation input from the listener, presenting a visual display to the listener oriented according to the display orientation input, and providing the orientation signal according to the orientation of the visual display.

10. The method of claim 8 further comprising receiving a touch input from the listener, and providing the orientation signal according to a shape of the touch input.

11. The method of claim 8 further comprising receiving an image of the listener, and providing the orientation signal according to a location of the listener in the image.

12. The method of claim 8 further comprising receiving an image of the listener, and providing the orientation signal according to recognition of facial features of the listener in the image.

13. A device that provides an audio output, the device comprising:
means for receiving a plurality of audio signals that include spatial position information;
means for receiving an orientation signal that provides an orientation of a speaker array relative to a listener, the speaker array including at least three speakers in a non-collinear arrangement; and
means for processing the plurality of audio signals according to the spatial position information and the orientation signal to create a speaker signal for each speaker in the speaker array such that the spatial position information is perceptible the listener.

14. The device of claim 13 further comprising means for receiving a display orientation input from the listener, means for presenting a visual display to the listener oriented according to the display orientation input, and means for providing the orientation signal according to the orientation of the visual display.

15. The device of claim 13 further comprising means for receiving a touch input from the listener, and means for providing the orientation signal according to a shape of the touch input.

16. The device of claim 13 further comprising means for receiving an image of the listener, and means for providing the orientation signal according to a location of the listener in the image.

17. The device of claim 13 further comprising means for receiving an image of the listener, and means for providing the orientation signal according to recognition of facial features of the listener in the image.

18. A device that provides an audio output, the device comprising:
a speaker array that is mechanically fixed to the device, the speaker array including four speakers to produce the audio output and located substantially at the vertices of a rectangle;
an orientation sensor, the orientation sensor to detect an orientation of the speaker array and provide an orientation signal;
an audio source to provide audio signals for a left channel and a right channel; and
an audio processor coupled to the speakers, the orientation sensor, and the audio source, the audio processor to receive the audio signals and the orientation signal, and to selectively route the audio signals of two of the speakers such that the left channel audio signal is routed to the speakers on the left of the device and the right channel audio signal is routed to the speakers on the right of the device based on the detected orientation of the speaker array.

19. The device of claim 18, wherein the orientation sensor is one of a compass, an accelerometer, and an inertial sensor.

20. The device of claim 18, wherein the orientation sensor includes a camera and an image recognition processor coupled to the camera, the orientation signal providing the orientation of the device relative to a user as detected by the image recognition processor.

21. A device that provides an audio output, the device comprising:
a speaker array that is mechanically fixed to the device, the speaker array including at least three speakers to produce the audio output and located substantially at the vertices of a polygon;
an orientation sensor, the orientation sensor to detect an orientation of the speaker array and provide an orientation signal;
an audio source to provide audio signals for a left channel and a right channel; and
an audio processor coupled to the speakers, the orientation sensor, and the audio source, the audio processor to receive the audio signals and the orientation signal, and to selectively route the audio signals such that the left channel audio signal is routed to the speakers on the left of the device and the right channel audio signal is routed to the speakers on the right of the device based on the detected orientation of the speaker array.

22. The device of claim 21, wherein the orientation sensor is one of a compass, an accelerometer, and an inertial sensor.

23. The device of claim 21, wherein the orientation sensor includes a camera and an image recognition processor coupled to the camera, the orientation signal providing the orientation of the device relative to a user as detected by the image recognition processor.

24. The device of claim 21, wherein the audio processor selectively does not route any of the audio signals to at least one speaker in the speaker array.

25. The device of claim 21, wherein at least one speaker in the speaker array receives one of the audio signals that is not routed by the audio processor.
